(19) United States
(12) Patent Application Publication
(10) Pub. No.: US 2004/0125812 A1
(43) Pub. Date: Jul. 1, 2004

(54) ADAPTER FOR INTERNETWORKING WWAN AND WLAN

(76) Inventors: Meng-Hua Kao, Taipei Hsien (TW); Ju-Nau Chang, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/248,190

(22) Filed: Dec. 25, 2002

(51) Int. Cl. H04Q 7/00; H04L 12/64; H04L 12/66

(52) U.S. Cl. 370/401; 370/338

(57) ABSTRACT

An adapter for internetworking a WWAN and a WLAN used as an access point in mobile wireless communication applications. The adapter includes a physical layer circuit and a data link layer circuit. The physical layer circuit includes a first connecting port and a second connecting port. The data link layer circuit includes a first media access controller, a second media access controller, a flow controller, and a bridge chipset for transforming the format of data packets.

### BACKGROUND OF INVENTION

1. Field of the Invention

The invention relates to an adapter, and more particularly, to an adapter for transforming a format of data packets in a data link layer circuit for internetworking a WWAN (Wireless Wide Area Network) and a WLAN (Wireless Local Area Network).

2. Description of the Prior Art

Nowadays, WAN technology includes various kinds of topics, such as wireless voice and internet connections over a long distance, and optima infrared and wireless frequency techniques for wireless connections over a short distance. The wireless apparatuses include a notebook, a desktop, a mobile computer, a personal digital assistant (PDA), a mobile phone, a tablet PC, a pager, and so on. People in motion can use their mobile phones to send or receive emails, passengers can use the internet through mobile computers wirelessly connected to access points in air ports, stations, and other public spaces, and users at home can deal with and transmit datasynchronously with desktop apparatuses.

A universal network architecture of data transmission has to been established so that various kinds of electric instruments manufactured by different factories can follow the same standard to connect to the same network. Therefore the OSI (Open System Interconnection) is established as the standard of the network architecture. Under the architecture, the seven-layer model has been framed and the physical layer, one of the seven layers, is terminal to users and transforms the signals of hardware into the signals which computers can receive. There is no standard protocol of the physical layer. The second layer from the bottom is the data link layer and data packets are transmitted correctly on the network in the data link layer. The seven-layer model also includes the network layer, the transport layer, and so on.

The wireless network can be divided into several categories according to the distance of the data transmission, which includes WWAN (Wireless Wide Area Network), WMAN (Wireless Metropolitan Area Network), WLAN (Wireless Local Area Network), and WPAN (Wireless Personal Area Network). The present invention relates to the WWAN and the WLAN closely. The WLAN technology allows users to connect to networks wirelessly through multiple antennas and satellite systems of service providers in wide areas. The WLAN technology allows users to connect to network wireless through access points in public spaces or buildings. The 802.11 specification of one to two million bites per second (Mbps) is established by IEEE in 1997. And the details of data transmission format and transmission rate are established in 802.11/a/b/g specification by IEEE.

Nowadays, the wireless communication technology is not capable of supporting the data transmission of real-time multimedia economically and efficiently. The main obstacles are lack of communication bandwidth, poor communication quality, and bad integration of various kinds of wireless networks. Up to now, the wireless application is imperative for information users, so how to integrate the WWAN and the WLAN for the communication industry and the academic field is an important topic. In U.S. Pat. Nos. 6,314,163 and 6,049,593, Acampora et al. pointed out a multi-hop concept of the WWAN and a basic operating method for improving the receiving signal quality. HungYun, et al. in GNAN Research Group published the method of internetworking the WLAN and the WWAN by integrating the one-hop WLAN and multi-hop WWAN into a new communication architecture to simulate the integrating effect.

The trend of communication development is integrating different communication specifications. The above-mentioned prior art is complex due to the need to reframe a new network architecture and the solution of the WLAN and WWAN integration can not be achieved by an add-on apparatus. The future will emphasize integrating the WLAN and the WWAN under the present architecture instead of building or reframing a new network architecture.

### SUMMARY OF INVENTION

It is therefore a primary objective of the claimed invention to provide an adapter used as an access point in mobile wireless communication applications for internetworking a WWAN and a WLAN to solve the above-mentioned problem of the prior art.

According to the claimed invention, an adapter for internetworking a WWAN and a WLAN is used as an access point in mobile wireless communication applications. The adapter comprises a physical layer circuit comprising a first connecting port connected to the physical layer circuit for receiving a first data packet from the WLAN and transmitting the first data packet to the WLAN, and a second connecting port connected to the physical layer circuit for receiving a second data packet from the WWAN and transmitting the second data packet to the WWAN. The adapter also comprises a data link layer circuit comprising a first media access controller connected to the first connecting port for receiving the first data packet from the first connecting port and transmitting the first data packet to the first connecting port, a second media access controller connected to the second connecting port for receiving the second data packet from the second connecting port and transmitting the second data packet to the second connecting port, a flow controller connected to the first media access controller and the second media access controller for processing the data flow, and a bridge chipset connected to the first media access controller and the second media access controller for changing a format of the first and second data packets.

According to the claimed invention, a method for using an adapter comprising a physical layer circuit and a data link layer for internetworking a WWAN and a WLAN comprises transmitting a first data packet from the WLAN to the physical layer circuit, transmitting the first data packet from the physical layer circuit to the data link layer circuit, transforming the first data packet into a second data packet by using the data link layer circuit, transmitting the second data packet from the data link layer circuit to the physical layer circuit, and transmitting the second data packet from the physical layer circuit to the WWAN.

It is an advantage of the claimed invention that the adapter can transform the data packet directly in the data link layer for internetworking the WLAN and the WWAN so that the WLAN and the WWAN can be integrated by the adapter under the claimed architecture instead of building or reframing a new network architecture.

These and other objectives and advantages of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of an adapter for internetworking a WLAN and a WWAN according to the present invention.

FIG. 2 is a functional block diagram of the adapter according to the present invention.

FIG. 3 is a flowchart of transmitting data from the WLAN to the WWAN according to the present invention.

### DETAILED DESCRIPTION

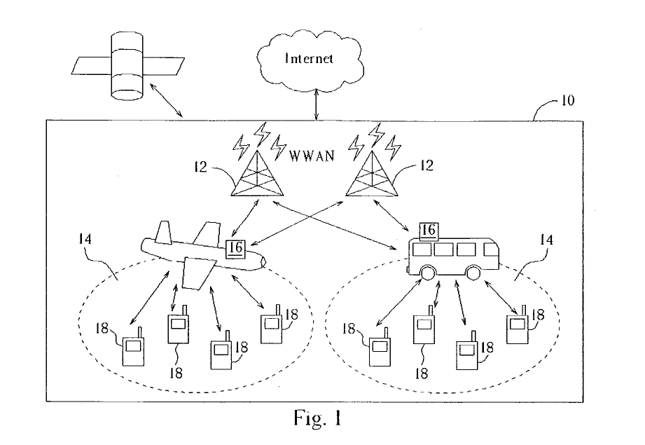

Please refer to FIG. 1. FIG. 1 is a schematic diagram of an adapter 16 for internetworking the WLAN 14 and the WWAN 10. The adapter 16 is capable of being set up in the mobile WWLAN, such as in buses, airplanes, trains, and other large vehicles. The adapter is equivalent to an access point capable of transmitting and receiving data in the WLAN 14, and the specification of the data flow in the WWLAN 14 has to conform to an IEEE 802.11a/b/g specification. There are a plurality of mobile clients 18, such as passengers with mobile communication apparatus in large vehicles. The mobile clients 18 can connect to the WLAN 14 anywhere and anytime in the vehicles. The adapter 16 according to the present invention in the vehicles is not only an access point in the WLAN 14 but is also capable of internetworking the WLAN 14 and the WWAN 10. There are a plurality of radio ports 12 (RPs) for connecting the WWAN 10 and the adapter 16. The radio ports 12 can communicate with a radio port controller unit (RPCU), which controls the radio ports 12, receives signals from the radio ports 12, transmits the signals to the radio ports 12, and is capable of associating with the radio ports in the WWAN 10. In FIG. 1, the data transmission in the WWAN 10 can be achieved by a satellite system and the format of the data transmission has to conform to the standard specification of the WWAN, such as GSM, GPRS, and 3G specifications. In addition, the radio port controller unit 12 connects to a widespread communication network, like the internet, the telephone network, and so on.

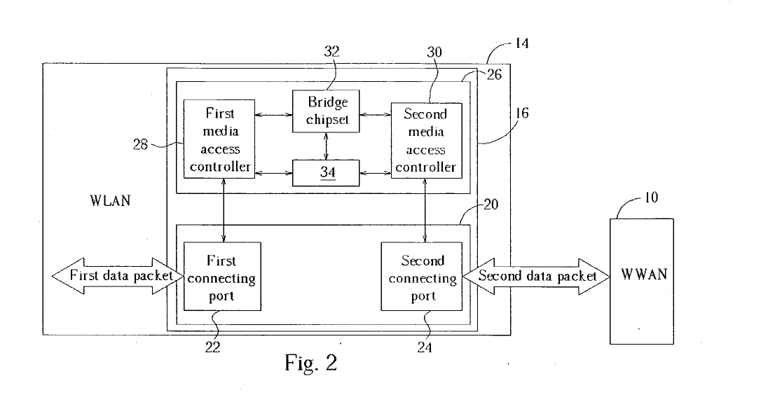

Please refer to FIG. 2. FIG. 2 is a functional block diagram of the adapter according to the present invention. For simplicity, the identical labeled components of FIG. 1 and of FIG. 2 have the same function. The adapter 16 includes a physical layer circuit 20 and a data link layer circuit 26. The physical layer circuit 20 includes a first connecting port 22 connected to the physical layer circuit 20 for receiving a first data packet from the WLAN 14 and transmitting the first data packet to the WLAN 14, and a second connecting port 24 connected to the physical layer circuit 20 for receiving a second data packet from the WWAN 10 and transmitting the second data packet to the WWAN 10. As above, the first data packet conforms to an IEEE 802.11a/b/g specification and the second data packet conforms to GSM, GPRS, and 3G specifications.

In FIG. 2, the data link layer 26 comprises a first media access controller 28 connected to the first connecting port 22 in the physical layer circuit 20 for receiving the first data packet from the first connecting port 22 and transmitting the first data packet to the first connecting port 22, a second media access controller 30 connected to the second connecting port 24 in the physical layer circuit 20 for receiving the second data packet from the second connecting port 24 and transmitting the second data packet to the second connecting port 24, a flow controller 34 connected to the first media access controller 28 and the second media access controller 30 for processing the data flow, and a bridge chipset 32 connected to the first media access controller 28 and the second media access controller 30 for changing a format of the first and second data packets. The bridge chipset 32 is a change over circuit capable of gauging a format of the data packet and transforming a header of the data packet if necessary for changing the data packet between the different specifications.

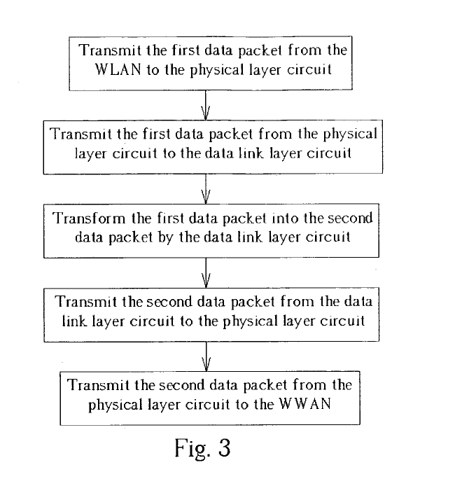

FIG. 3 is a flowchart of transmitting data from the WLAN 14 to the WWAN 10 by the adapter 16. For simplicity, the identical labeled components of FIG. 1 and of FIG. 2 and of FIG. 3 have the same function. The first connecting port 22 in the physical layer circuit 20 is capable of receiving the first data packet, which conforms to an IEEE 802.11a/b/g specification, from the WLAN 14 and transmits the first data packet to the first media access controller 28. Then the first data packet is transformed into the second data packet by the bridge chipset 32 in the data link layer circuit 26, then the second media access controller 30 is capable of transmitting the second data packet which conforms to GSM, GPRS, and 3G specifications from the data link layer circuit 26 to the second connecting port 24 in the physical layer circuit 20, and at last the second data packet is transmitted by the second connecting port 24 in the physical layer circuit 20 to the WWAN 10 to complete the data transmission.

The flow controller 34 in the adapter 16 is capable of gauging a flow direction of the first and second data packets, and when data packet flow is from the first media access controller 28 to the second media access controller 30, the flow controller 34 is capable of commanding the bridge chipset 32 to transform a format of the first data packet from the first media access controller 28 into a format of the second data packet and to transmit the second data packet to the second media access controller 30. When the data packet flow is from the second media access controller 30 to the first media access controller 28, the flow controller 34 is capable of commanding the bridge chipset 32 to transform the format of the second data packet from the second media access controller 30 into the format of the first data packet and to transmit the first data packet to the first media access controller 28. When the data packet flow is from the first media access controller 28 to the first media access controller 28, users only transmit data packets in the WLAN 14 and the format of the data packet need not to be transformed. That means the bridge chipset 32 does not work in this condition and the adapter 16 is a pure access point in the WLAN 14.

In contrast to the prior art, the present invention adapter can be utilized as an access point in mobile wireless communication and the adapter can transform the data packet directly in the data link layer for internetworking the WLAN and the WWAN so that the WLAN and the WWAN can be integrated by the adapter under the present architecture instead of building or reframing a new network architecture.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An adapter for internetworking a WWAN and a WLAN used as an access point in mobile wireless communication applications, the adapter comprising:
a physical layer circuit comprising:
a first connecting port connected to the physical layer circuit for receiving a first data packet from the WLAN and transmitting the first data packet to the WLAN; and
a second connecting port connected to the physical layer circuit for receiving a second data packet from the WWAN and transmitting the second data packet to the WWAN; and
a data link layer circuit comprising;
a first media access controller connected to the first connecting port for receiving the first data packet from the first connecting port and transmitting the first data packet to the first connecting port;
a second media access controller connected to the second connecting port for receiving the second data packet from the second connecting port and transmitting the second data packet to the second connecting port;
a flow controller connected to the first media access controller and the second media access controller for processing the data flow; and
a bridge chipset connected to the first media access controller and the second media access controller for changing a format of the first and second data packets.

2. The adapter of claim 1 wherein the flow controller is capable of gauging a flow direction of the first and second data packet, and when data packet flow is from the first media access controller to the second media access controller, the bridge chipset is capable of transforming a format of the first data packet in the first media access controller into a format of the second data packet, and when the data packet flow is from the second media access controller to the first media access controller, the bridge chipset is capable of transforming the format of the second data packet in the second media access controller into the format of the first data packet.

3. The adapter of claim 1 wherein the bridge chipset is a change over circuit for changing the first data packet from the first media access controller and the second data packet from the second media access controller.

4. The adapter of claim 1 wherein the data link layer circuit further comprises a non-volatile random access memory (NVRAM) for storing programs of the bridge chipset and the flow controller.

5. The adapter of claim 1 wherein the first data packet conforms to an IEEE 802.11a/b/g specification.

6. The adapter of claim 1 wherein the second data packet conforms to GSM, GPRS, and 3G specifications.

7. A method for using an adapter comprising a physical layer circuit and a data link layer for internetworking a WWAN and a WLAN, the method comprising:
transmitting a first data packet from the WLAN to the physical layer circuit;
transmitting the first data packet from the physical layer circuit to the data link layer circuit;
transforming the first data packet into a second data packet by using the data link layer circuit;
transmitting the second data packet from the data link layer circuit to the physical layer circuit; and
transmitting the second data packet from the physical layer circuit to the WLAN.

8. The method of claim 7 wherein the physical layer circuit comprises a first connecting port connected to the physical layer circuit for receiving the first data packet from the WLAN and a second connecting port connected to the physical layer circuit for transmitting the second data packet to the WWAN.

9. The method of claim 7 wherein the data link layer circuit comprises a first media access controller connected to the first connecting port in the physical layer circuit for receiving the first data packet from the first connecting port and a second media access controller connected to the second connecting port in the physical layer circuit for transmitting the second data packet to the second connecting port.

10. The method of claim 7 wherein the data link layer circuit further comprises a bridge chipset connected to the first media access controller and the second media access controller for transforming a format of the first data packet into a format of the second data packet.

11. The method of claim 7 wherein the data link layer circuit further comprises a flow controller connected to the first media access controller and the second media access controller for controlling data flow and gauging a data flow direction

12. The method of claim 7 wherein the first data packet conforms to an IEEE 802.11a/b/g specification.

13. The method of claim 7 wherein the second data packet conforms to GSM, GPRS, and 3G specifications.
